(19) United States
(12) Patent Application Publication
(10) Pub. No.: US 2009/0270116 A1
(43) Pub. Date: Oct. 29, 2009

(54) Device and Method for Replying to Received Text Messages

(75) Inventors: Qingfeng Bao, Shanghai (CN); Ke Song Han, Shanghai (CN); Xin He, Shanghai (CN)

Correspondence Address: MOTOROLA INC, 600 NORTH US HIGHWAY 45, W4 - 39Q, LIBERTYVILLE, IL, 60048-5343, US

(73) Assignee: Motorola, Inc., Schaumburg, IL (US)

(21) Appl. No.: 12/109,689

(22) Filed: Apr. 25, 2008

(51) Int. Cl. H04Q 7/20

(52) U.S. Cl. 455/466

(57) ABSTRACT

An electronic device and a method for replying to a received text message received at the electronic device. The method comprises composing a reply text message on a common display screen of the device whist concurrently displaying, on the common display screen, a body of text contained in the received text message. The method performs transmitting the reply text message without the body of text contained in the received text message and automatically removing, in response to the transmitting, the reply text message from the common display screen.

The present invention relates generally to a method for replying to a received text message and an electronic device for replying to a received text message. The invention is particularly useful for, but not necessarily limited to, replying to a received Short Message Service messages, Multimedia Message Service messages and Enhanced Message Service messages.

### BACKGROUND OF THE INVENTION

Electronic devices such as mobile telephones, hand held personal computers and personal digital assistants (PDA's) with mobile telephone capabilities have multiple functionalities. Such functionalities include the ability to make and receive telephone calls; take digital photographs; play games; play music; play videos; connect to television broadcasts; navigate menus; view web pages; and view, prepare, send and receive text messages. Such messages are typically provided by Short Message Service (SMS) applications, Multimedia Message Service (MMS) applications and Enhanced Message Service (EMS) applications.

Sending text messages by an SMS application has become very popular and it is one of the most frequently used applications on mobile telephone. However, unlike conventional email text messaging, there is a length limitation when sending or receiving a single SMS message. Therefore when composing a reply text message in response to a received SMS or EMS text message, the received text message is not concurrently displayed on the screen of the mobile telephone along with the reply text message. This is mainly because the received text message is not appended to the transmitted reply SMS text message (due to the SMS length limitation) and consequently it has been assumed that there is no benefit in concurrently displaying the received text message whilst composing the reply text message. MMS applications have evolved from SMS messaging, as a result a MMS received text message is not appended to the transmitted reply MMS text message nor is the received text message appended to the transmitted reply MMS text message.

When replying to a received text message inconvenience may occur since the received text message is not concurrently displayed on the screen of the mobile telephone along with the reply text message that is being composed. For instance, if the received text message has unfamiliar names or unfamiliar words; or if it has several issues requiring answers; or if it has address that is not to easy to remember, then a user may have to write down at least part of the text message before composing the reply message or memorise the major points in the received text message before composing the reply message.

### BRIEF DESCRIPTION OF THE DRAWINGS

In order that the invention may be readily understood and put into practical effect, reference now will be made to exemplary embodiments as illustrated with reference to the accompanying figures, wherein like reference numbers refer to identical or functionally similar elements throughout the separate views. The figures together with a detailed description below, are incorporated in and form part of the specification, and serve to further illustrate the embodiments and explain various principles and advantages, in accordance with the present invention, where:

FIG. 1 is a schematic diagram illustrating schematic diagram of an electronic device typically in the form of a mobile telephone that performs a method for replying to a received text message in accordance with embodiments of the invention;

FIG. 2 is a flow diagram illustrating a method for replying to a received text message in accordance with embodiments of the invention;

FIG. 3 illustrates the common display screen of the electronic device of FIG. 1 that is concurrently displaying a composed text message and a body of text contained in a received text message, in accordance with embodiments of the invention;

FIG. 4 illustrates the common display screen of the electronic device of FIG. 1 after the method of FIG. 2 has performed the automatically removing the reply text message inclusive of maintaining displaying the body of text;

FIG. 5 illustrates the common display screen of the electronic device of FIG. 1 after the method of FIG. 2 has performed the automatically removing the reply text message inclusive of removing the body of text; and

FIG. 6 illustrates the common display screen the electronic device of FIG. 105 displaying overlapping text in accordance with an embodiment of the invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail embodiments that are in accordance with the present invention, it should be observed that the embodiments reside primarily in device components and method steps related to an electronic device and a method for replying to a received text message. Accordingly, the device components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that device components or method steps that comprises a list of elements does not include only those elements but may include other elements not expressly listed or inherent to such a device component or method steps. An element proceeded by “comprises . . . a” does not, without more constraints, preclude the existence of additional identical elements in the method, or device that comprises the element.

According to one aspect of the present invention there is provided a method for replying to a received text message received at an electronic device. The method comprises composing a reply text message on a common display screen of the electronic device whist concurrently displaying, on the common display screen, a body of text contained in the received text message; Transmitting the reply text message without the body of text contained in the received text message; and automatically removing, in response to the transmitting, the reply text message from the common display screen.

According to another aspect of the present invention there is provided an electronic device comprising a processor a radio frequency communications unit coupled to the processor and a common display screen coupled to the processor.

After a received text message is received by the radio frequency communications unit, the processor controls the common display screen so that during composing of a reply text message on the common display screen a body of text contained in the received text message is also concurrently displayed on the common display screen. Also, the reply text message is transmitted, by the radio frequency communications unit, without the body of text contained in the received text message. In response to the text message being transmitted, the processor automatically removes reply text message from the common display screen.

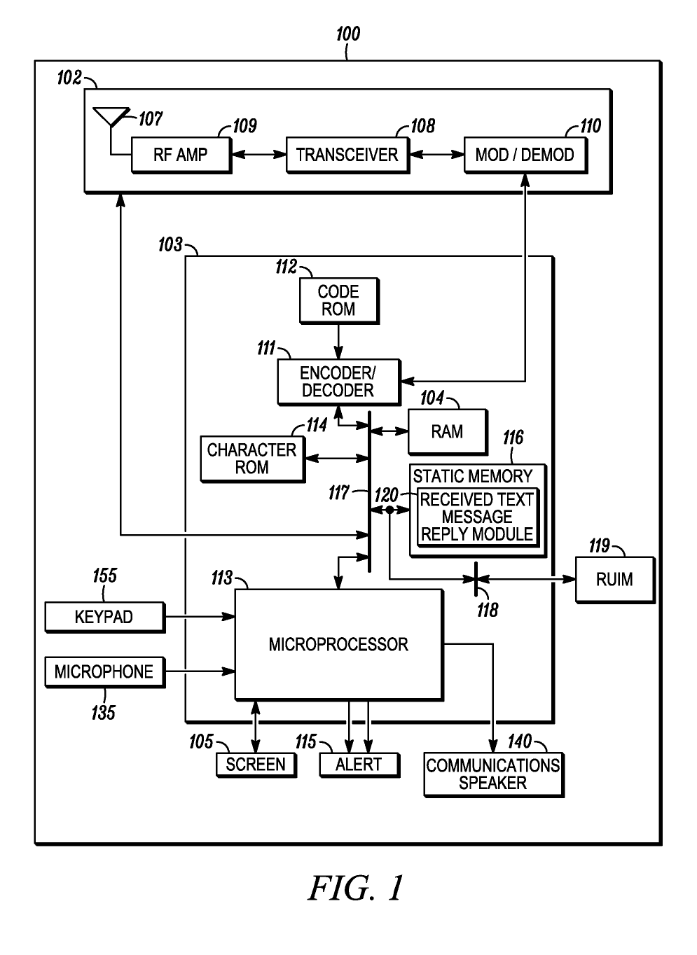

Referring to FIG. 1, there is illustrated a schematic diagram of an electronic device 100, such as a portable wireless communications device typically in the form of a mobile telephone comprising a radio frequency communications unit 102 coupled to be in communication with a processor 103. The electronic device 100 also includes a common display screen 105. There is also an alert module 115 that typically contains an alert speaker, vibrator motor and associated drivers. The common display screen 105, and alert module 115 are coupled to be in communication with the processor 103. Although only the common display screen 105 is illustrated, it will be apparent to a person skilled in the art that the electronic device 100 may in some embodiments have an auxiliary display screen. For instance, an auxiliary display screen is common if the electronic device 100 has a two part closable housing, wherein the auxiliary display screen is visible when the closable housing is in a closed position and the common display screen 105 is typically only viewable when the closable housing is in an opened position.

The processor 103 includes an encoder/decoder 111 with an associated code Read Only Memory (ROM) 112 for storing data for encoding and decoding voice or other signals that may be transmitted or received by the electronic device 100. The processor 103 also includes a micro-processor 113 coupled, by a common data and address bus 117, to the encoder/decoder 111, the radio frequency communications unit 102, a character Read Only Memory (ROM) 114, a Random Access Memory (RAM) 104, static programmable memory 116 and a Removable User Identity Module (RUIM) interface 118. The static programmable memory 116 and a RUIM card 119 (commonly referred to as a Subscriber Identity Module (SIM) card) operatively coupled to the RUIM interface 118 each can store, amongst other things, Preferred Roaming Lists (PRLs), subscriber authentication data, selected incoming text messages and a Telephone Number Database (TND phonebook) comprising a number field for telephone numbers and a name field for identifiers associated with one of the numbers in the name field. The RUIM card 119 and static programmable memory 116 may also store passwords for allowing accessibility to password-protected functions.

The micro-processor 113 has ports for coupling to the common display screen 105, and the alert module 115. Also, micro-processor 113 has ports for coupling to a microphone 135, a communications speaker 140, and keypad 155. The character Read Only Memory 114 stores code for decoding or encoding text messages that may be received by the radio frequency communications unit 102. In this embodiment the character Read Only Memory 114 and static programmable memory 116 also stores Operating Code (OC) for the micro-processor 113 and code for performing functions associated with the electronic device 100. Furthermore, the static programmable memory 116 includes a received text message reply module 120 that provides code to the microprocessor 113 for performing a method for replying to a received text message as described later in this specification.

Typically the radio frequency communications unit 102 is a combined receiver and transmitter having an antenna 107. The radio frequency communications unit 102 has a transceiver 108 coupled to the antenna 107 via a radio frequency amplifier 109. The transceiver 108 is also coupled to a combined modulator/demodulator 110 that couples the radio frequency communications unit 102 to the processor 103.

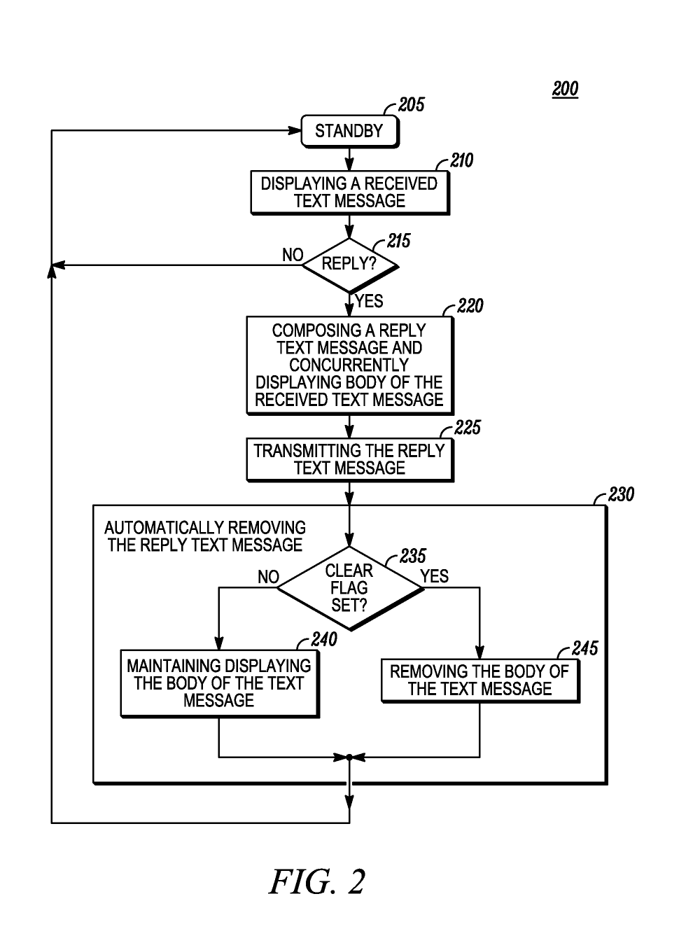

Referring to FIG. 2 there is illustrated a flow diagram for performing a method 200 for replying to a received text message that is typically received at the electronic device 100. At a standby block 205, the electronic device 100 is in standby mode ready to receive an incoming call or text message or ready, in response to an input command from the keypad 155 (or any other input interface such as a touch screen), to invoke a function such as taking digital photographs, playing games, playing music, playing videos, connecting to television broadcasts, navigating menus, connecting to web pages or viewing, preparing, sending and receiving text messages.

After a received text message is received at the electronic device 100, via the radio frequency communications unit 102, a view message command may be entered at the keypad 155 and the method 200, at a displaying block 210, performs displaying the received text message on the common display screen 105. If a user does not wish to reply to the received text message, or compose a text message relating to the received text message, then upon a terminate command being entered (typically via the keypad 155) the method 200 determines, at a test block 215, that no reply is necessary. As a result, the method 200 returns to the standby block 205 and the electronic device 100 again operates in standby mode.

If upon viewing the received text message on the common display screen 105 at the displaying block 210 the user wishes to reply to the received text message, or compose a text message relating to the received text message, then upon a reply command being entered the method 200, at the test block 215, determines that a reply is message is required to be composed. As a result, the method 200 performs, at a composing block 220, composing a reply text message on the common display screen 105 of the electronic device 100 whist concurrently displaying, on the common display screen 105, a body of text contained in the received text message.

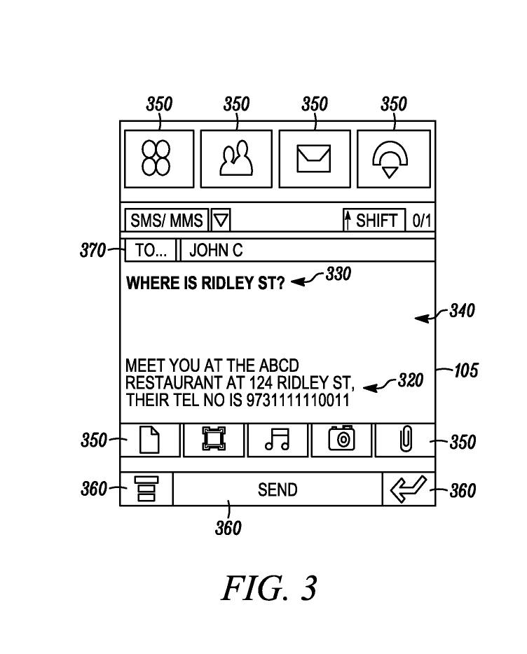

Referring briefly to FIG. 3, there is illustrated the common display screen 105 concurrently displaying the composed text message and the body of text contained in the received text message. As shown, the body of text is displayed as a background text 320 on the common display screen 105 and the reply text message is displayed as foreground text 330 on the common display screen 105. The background text 320 is fainter than the foreground text 330, more specifically the background text 320 is of a color or shade similar to a background 340 displayed on the common display screen 105, whereas the foreground text 330 is of a contrasting color or shade to that of the background 340. Also shown in FIG. 3 are icons 350, menu selection indicia 360 and an intended recipient (or recipients) address filed 370 that are typically displayed on the common display screen 105.

Returning back to FIG. 2, after the reply text message has been composed the user invokes a send message typically by actuation of a key on the keypad 155. The method 200 then, at a transmitting block 225, performs transmitting, via the radio frequency communications unit 102, the reply text message without the body of text contained in the received text message. Next, the method 200, at an automatically removing block 230, performs automatically removing, in response to the transmitting, the reply text message from the common display screen 105. Inside the automatically removing block 230 there is a clear flag test block 235, maintaining displaying block 240 and a removing the body of the text block 245. The clear flag test block 235 checks to determine if a clear flag has previously been set by the user. If the clear flag in not set then there is performed, at the maintaining displaying block 240, a maintaining displaying the body of text on the common display screen 105.

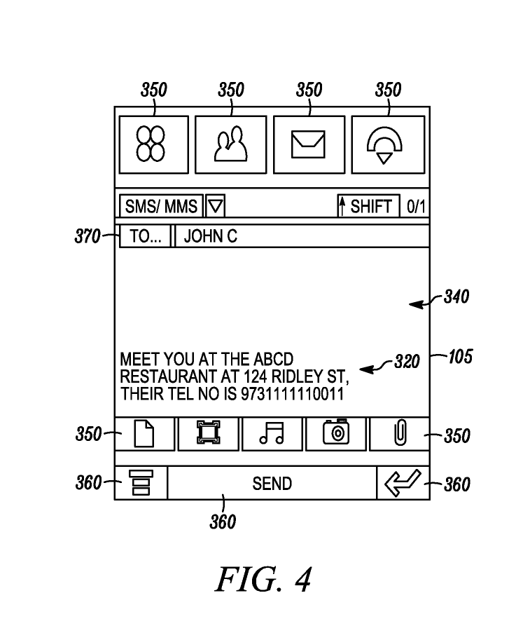

Referring briefly to FIG. 4, there is illustrated the common display screen 105 after the method has performed the automatically removing of block 230 inclusive of the maintaining displaying block 240. Hence, the automatically removing of block 230 includes maintaining displaying the body of text, shown as the background text 340, on the common display screen 105.

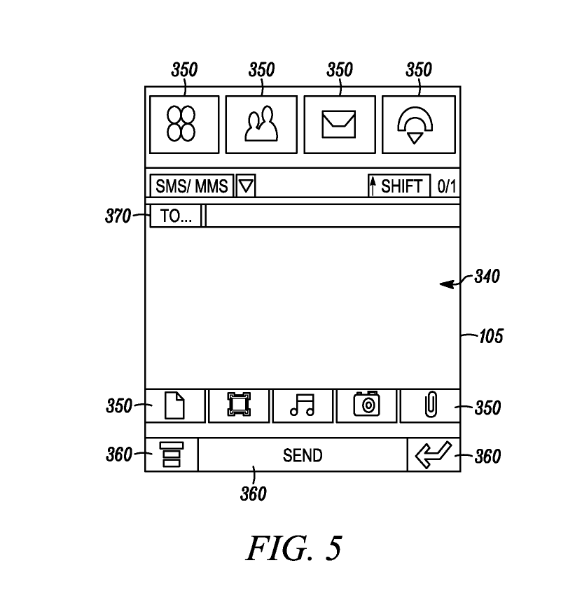

Returning back to FIG. 2, if the clear flag in not set then there is performed, at the removing the body of the text block 245, a removing the body of text from the common display screen 105. Referring briefly to FIG. 5, there is illustrated the common display screen 105 after the method has performed the automatically removing of block 230 inclusive of the removing the body of text block 245. Hence, the automatically removing, of block 230, includes automatically removing the body of text from the common display screen 105.

After completion of the automatically removing block 230 the method 200 returns to the standby block 202 and the electronic device 100 is again in standby mode ready to receive an incoming call or text message or ready, in response to an input command from the keypad 155, to invoke a function such as taking digital photographs, playing games, playing music, playing videos, connecting to television broadcasts, navigating menus, connecting to web pages or viewing, preparing, sending and receiving text messages.

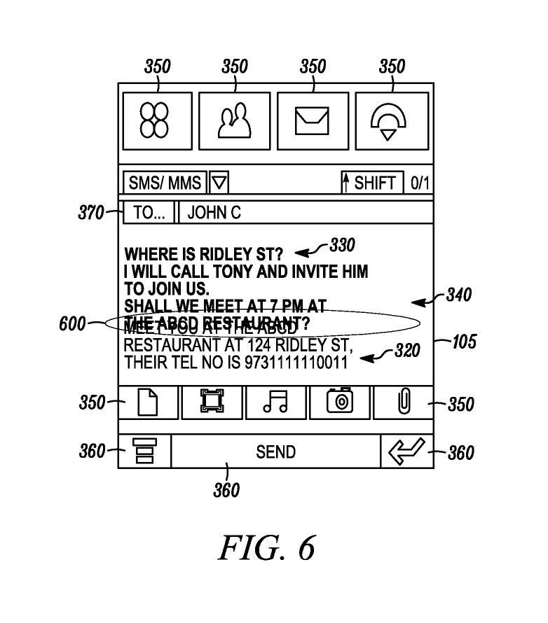

Referring to FIG. 6, there is illustrated the common display screen 105 displaying overlapping text. In this embodiment, if during the composing, at the composing block 220, the reply text message is relatively long and displayed as the foreground text 330 and the body of text is displayed as the background text 320, then in one embodiment at least part the of foreground text 330 may overlap the background text 320. Therefore at an overlapping area 600 on the common display screen at least part of the foreground text 330 overlays at least part of the background text 320, however, although partially obscured, the background text 320 is still viewable.

Advantageously, the present invention provides a method and electronic device for replying to a received text message after the received text message is received by the radio frequency communications unit 102. The received text message is typically an SMS, MMS or an EMS message in which the processor 103 controls the common display screen 105 so that during composing of a reply text message on the common display screen 105 the body of text contained in the received text message is also concurrently displayed on the common display screen 105. Hence, a user can view the received text message on the common display screen 105 whilst composing the reply text message. There is therefore no need for the user to write down at least part of the received text message before composing the reply message or memorise the major points in the received text message before composing the reply message. The reply text message is transmitted, by the radio frequency communications unit 102, without the body of text contained in the received text message as is the case with SMS, MMS or an EMS messaging and in response to the text message being transmitted, the processor 103 automatically removes reply text message from the common display screen 105.

It will be appreciated that the embodiment of the present invention described herein may be comprised of one or more conventional processors and unique stored program instructions that control the one or more processors to implement, in conjunction with certain non-processor circuits, some, most, or all of the functions of the electronic device 100 as described herein. The non-processor circuits may include, but are not limited to, a radio receiver, a radio transmitter, signal drivers, clock circuits, power source circuits, and user input devices. As such, these functions may be interpreted as steps of the method 200 to perform at least one application operating on the electronic device 100. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of the present invention. The benefits, advantages, solutions to problems, and any elements that may cause any benefit, advantage, or solution to occur or become more pronounced are not to be construed as critical, required, or essential features or elements of any or all of the claims. The invention is defined solely by the appended claims including any amendments made during the pendency of this application and all equivalents of those claims.

We claim:

1. A method for replying to a received text message received at an electronic device, the method comprising:
Composing a reply text message on a common display screen of the electronic device whist concurrently displaying, on the common display screen, a body of text contained in the received text message;
Transmitting the reply text message without the body of text contained in the received text message; and
automatically removing, in response to the transmitting, the reply text message from the common display screen.

2. A method for replying to a received text message, as claimed in claim 1, wherein the automatically removing includes automatically removing the body of text from the common display screen.

3. A method for replying to a received text message, as claimed in claim 1, wherein the automatically removing includes maintaining displaying the body of text on the common display screen.

4. A method for replying to a received text message, as claimed in claim 1, wherein the body of text is displayed as a background on the common display screen.

5. A method for replying to a received text message, as claimed in claim 4, wherein the reply text message is displayed as foreground text on the common display screen.

6. A method for replying to a received text message, as claimed in claim 1, wherein the body of text is displayed as foreground text on the common display screen and the reply text message is displayed as a background text on the common display screen.

7. A method for replying to a received text message, as claimed in claim 6, wherein the background text is of a color or shade similar to a background displayed on the common display screen.

8. A method for replying to a received text message, as claimed in claim 7, wherein the foreground text is of a contrasting color or shade to that of the background.

9. A method for replying to a received text message, as claimed in claim 8, wherein at least part of the foreground text overlays at least part of the background text.

10. A method for replying to a received text message, as claimed in claim 1, wherein the electronic device is a portable wireless communications device.

11. A method for replying to a received text message, as claimed in claim 1, wherein the received text message is selected from the group consisting of SMS, MMS and EMS messages.

12. An electronic device comprising:
A processor;
A radio frequency communications unit coupled to the processor; and
A common display screen coupled to the processor,
Wherein after a received text message is received by the radio frequency communications unit, the processor controls the common display screen so that during composing of a reply text message on the common display screen a body of text contained in the received text message is also concurrently displayed on the common display screen, and wherein the reply text message is transmitted, by the radio frequency communications unit, without the body of text contained in the received text message; and in response to the text message being transmitted, the processor automatically removes reply text message from the common display screen.

13. An electronic device, as claimed in claim 12, wherein in response to the text message being transmitted, the processor automatically removes the body of text from the common display screen.

14. An electronic device, as claimed in claim 12, wherein in response to the text message being transmitted, the processor automatically removes the body of text on the common display screen.

15. An electronic device, as claimed in claim 12, wherein the body of text is displayed as a background text on the common display screen.

16. An electronic device, as claimed in claim 15, wherein the reply text message is displayed as foreground text on the common display screen.

17. An electronic device, as claimed in claim 12, wherein the body of text is displayed as foreground text on the common display screen and the reply text message is displayed as a background text on the common display screen.

18. An electronic device, as claimed in claim 17, wherein the background text is of a color or shade similar to a background displayed on the common display screen.

19. An electronic device, as claimed in claim 18, wherein the foreground text is of a contrasting color or shade to that of the background.

20. An electronic device, as claimed in claim 19, wherein at least part of the foreground text overlays at least part of the background text.

21. An electronic device, as claimed in claim 12, wherein the received text message is selected from the group consisting of SMS, MMS and EMS messages.
